(19) United States
(12) Patent Application Publication
(10) Pub. No.: US 2003/0165679 A1
(43) Pub. Date: Sep. 4, 2003

(54) Optical fibre with coloured coating

(76) Inventors: Claudio Bosisio, Brembate (IT); Mauro Maritano, Monza (IT); Antonio Zaopo, Milano (IT); Antonio Campana, Milano (IT)

Correspondence Address: FINNEGAN, HENDERSON, FARABOW, GARRETT & DUNNER, LLP, 1300 I STREET, NW, WASHINGTON, DC, 20005, US

(21) Appl. No.: 10/220,346

(22) PCT Filed: Feb. 15, 2001
(86) PCT No.: PCT/EP01/01687

(30) Foreign Application Priority Data
Mar. 3, 2000 (EP) 00104609.3

(51) Int. Cl. G02B 6/44

(52) U.S. Cl. 428/375; 385/102

(57) ABSTRACT

An optical fibre with a coloured coating, in particular a primary coating, is described, together with a polymer composition for said coating in which an organic dye is dissolved in the base cross-linkable mixture. The optical fibres of the invention show a lesser signal attenuation and a more stable primary coating coloration with the passage of time.

This invention relates to an optical fibre with a coloured coating layer, and a cross-linkable formulation suitable for application as said coating. Specifically, the invention relates to an optical fibre comprising at least one coloured primary coating layer and at least one secondary coating layer surrounding said primary coating, and a cross-linkable formulation suitable for application as said primary coating.

Optical fibres commonly consist of a glass part (typically of about 125 μm diameter), within which the transmitted optical signal is confined, and a typically polymer coating surrounding the glass part for substantially protective purposes. This protective coating typically comprises a first coating layer positioned directly on the glass surface and known as “primary coating” or more briefly “primary”, with typically a thickness of between about 25 μm and about 35 μm. This primary coating is generally covered with a second coating layer known as “secondary coating” or more briefly “secondary”, with typically a thickness of between about 10 μm and about 30 μm.

These polymer coatings can be obtained from formulations comprising oligomers and monomers, which are generally cross-linked by UV irradiation in the presence of a suitable photoinitiator. These oligomers and monomers can for example comprise acrylic functions able to cross-link to form the final resin. The two aforesaid coatings differ, inter alia, by the modulus of elasticity of the cross-linked material. In this respect, the material forming the primary coating is a relatively soft material with a modulus of elasticity of between about 0.5 MPa and about 2.0 MPa, whereas the material forming the secondary coating is relatively harder, with a modulus of elasticity of between about 300 MPa and about 1000 MPa.

The optical fibre composed in this manner has generally a total diameter of about 250 μm. However for particular applications this total diameter can be reduced to about 180-200 μm.

In addition, where one and the same cable internally contains several optical fibres, the operator must be able to identify the different fibres with certainty, hence it is convenient to colour the various fibres with different identifying colours. Typically, an optical fibre is colour-identified by surrounding the secondary coating with a third coloured polymer layer, commonly known as “ink”, having a thickness typically of between about 2 μm and about 10 μm, or alternatively by introducing a coloured pigment directly into the formulation of the secondary coating.

Optionally, the coloured fibres can be then combined into groups of several fibres, typically in the form of fibre optic ribbons, to facilitate their insertion into and recognition within a cable.

Typically from 4 to 24 optical fibres are arranged in parallel to form a fibre optic ribbon and are then covered with a single covering known as the common coating, of composition and physical properties similar to those of the secondary coating.

For colouring the secondary coating, WO 90/13579 suggests for example to introduce a pigment directly into that polymer formulation which forms the secondary coating. However, according to this patent application, the use of common pigments, which contain particles of diameter exceeding 5 μm, to colour the secondary coating can give rise to microcurvatures in the glass part of the optical fibre, a phenomenon known as “microbending”, with consequent attenuation of the transmitted signal. Moreover the presence of such pigments in the secondary coating slows down its cross-linking rate. Consequently, said patent application suggests the use of pigments with a particle diameter of less than 1 μm and the use of an acyl-phosphine oxide as photoinitiator.

However, as stated for example in EP-A-0432931, the use of such pigments presents problems which negatively influence the production and performance of the coloured optical fibre.

For example, as the pigment dispersion within the base polymer material of the coating is not stable, the mixture tends to separate into two distinct phases, and at the same time pigment particle agglomerates may form. As stated in that patent application, this formation of pigment particle agglomerates can induce microbending within the glass part of the fibre, with consequent attenuation of the signal transmitted by the optical fibre.

EP-A-0432931 therefore proposes to replace these pigments with polymer dyes, ie macromolecules in which an organic colouring unit (chromophore) is chemically bonded to a polymer chain. In that patent application, these polymer dyes are compared not only with the said pigments but also with conventional dyes. In this respect, as stated in that patent application, conventional dyes suffer from stability problems, such as exudation of the dye from the fibre coating towards the cable filler material. The said patent application indicates the polymer dyes described in U.S. Pat. No. 3,157,633 as examples of suitable dyes.

The Applicant has however observed that precisely because of their macromolecular structure, these dyes have necessarily to be used in an averagely high quantity to obtain adequate coloration. In this respect, from the structural formulas of the dyes described in the said U.S. Pat. No. 3,157,633, it can be seen that the macromolecular part of these dyes does not possess chromophore groups, because of which it does not impart any colour to the polymer material within which the dye is dispersed. Consequently to achieve an adequate concentration of organic units with chromophore groups, ie such as to provide the coating with a sufficient colour intensity, a relatively large quantity of dye must be used. For example, as stated in the cited EP-A-0432931, to achieve the desired colour intensity, 2 parts by weight of polymer dye must be added to 98 parts by weight of the mixture to be cross-linked.

The Applicant has also observed that the polymer dyes described in the cited U.S. Pat. No. 3,157,633 are fugitive tint dyes, ie dyes produced specifically to give only a temporary colour to the fabrics to which they are applied, they being subsequently easily removed by washing with water. Consequently, because of the high water solubility of these polymer dyes, there is a possibility that those dyes incorporated into the polymer coating of an optical polymer dye may solubilize following prolonged presence of the fibre in an environment of high relative humidity, with the risk of decoloration of the coating.

Although optical fibres are generally coloured by the aforesaid methods, ie by adding a layer of ink on the outside of the secondary coating or by inserting a pigment or polymer dye into the secondary coating of the optical fibre, solutions are also described in the state of the art by which the primary coating is coloured.

For example, to display or rather verify that the primary coating has been properly peeled off when making joints, JP 57040203 generically describes coloration of the primary coating by adding pigments. However, the Applicant has observed that according to the solution proposed in that document, pigment particles lie in direct contact with the glass part of the fibre, with consequent accentuation of the aforedescribed microbending.

Based on the experience of the Applicant and the aforedescribed known art, the problem of effectively colouring the coating of a optical fibre without using pigments which can give rise to said microbending, or dyes which can diffuse out of the polymer coating, is still unsolved. In particular, it is relatively complicated to provide the primary coating of such a fibre with adequate coloration.

The Applicant has also noted the requirement for an optical fibre, the polymer coating of which can be coloured easily and quickly, without it being necessary to control the particle size of the dye used, so making any consideration of this parameter unnecessary.

The Applicant has also observed that colouring the primary coating allows the optical fibre production rate to be increased. In this respect, the absence of colour in the secondary coating surrounding the primary coating (hence substantially transparent to the UV radiation applied for cross-linking) enables the cross-linking of the primary coating to be adequately completed even when already surrounded by the secondary coating. Moreover the absence of colour in the secondary coating enables the rate of cross-linking to be increased (for equal UV irradiation powers), because in this case the radiant energy is not partly absorbed by chromophore groups present in this coating, as instead happens in a coloured secondary coating.

According to the finding of the Applicant, a polymer coating layer of an optical fibre, in particular a primary coating, can be adequately coloured without the aforedescribed drawbacks by using an organic dye which is soluble in the base cross-linkable system of this coating and substantially insoluble or only poorly soluble in water. The expression “base cross-linkable system” (also indicated by the expression “base cross-linkable formulation or composition or mixture”) signifies a liquid mixture, comprising oligomers and monomers with reactive functions plus typically a photoinitiator, which when cross-linked forms the polymer coating of the optical fibre.

The solubility of the organic dye in the base cross-linkable system enables this dye to be adequately dispersed within said system, without the risk of forming particle aggregates which could give rise to the aforedescribed microbending. Again, the low solubility of the same dye in water means that the dye does not diffuse out of the coating if the fibre is in a high humidity environment. Moreover, in the particular case of a coloured primary coating which is itself covered with a secondary coating, the dye contained in the primary coating does not diffuse into any cable filler mass, the term “filler mass” meaning oil or grease substances used to fill the longitudinal cavities of the optical cables. As observed by the Applicant, the said dye solubility in the base cross-linkable system can be advantageously related to the solubility of this dye in ethyl alcohol, hence making selection of suitable dyes particularly easy.

A first aspect of this invention relates to an optical fibre comprising a coloured polymer coating formed from a cross-linkable system characterised in that said polymer coating comprises an organic dye soluble in said cross-linkable system and substantially insoluble in water. This cross-linkable system comprises typically at least one oligomer, at least one monomer, at least one dye substance and, preferably, at least one photoinitiator.

According to a preferred embodiment of the invention, this coloured polymer coating is a primary coating, preferably coated in its turn with a secondary coating.

Preferably the solubility of this dye in the cross-linkable system is greater than or equal to 5 g/l, a solubility of greater than or equal to 20 g/l being more preferred. Particularly preferred are those organic dyes having a solubility in the cross-linkable system of greater than or equal to about 100 g/l.

According to the invention, the term “dye substantially insoluble in water” signifies a dye with substantially zero or very low solubility in water. In particular, this dye has a solubility in water of less than or equal to 0.5 g/l, this solubility corresponding to the quantity of dye which dissolves in water at ambient temperature. Preferably, the solubility of this dye in water is less than or equal to 0.1 g/l, and more preferably less than or equal to about 0.05 g/l.

This dye also preferably has a solubility in ethyl alcohol of greater than or equal to 5 g/l, the solubility in ethyl alcohol being the maximum quantity of dye which dissolves in ethyl alcohol at ambient temperature, until saturation is reached. This solubility is preferably greater than or equal to 20 g/l, and more preferably greater than or equal to about 100 g/l.

Preferably, an organic dye of this invention is a non-polymeric organic dye, the expression “non-polymeric organic dye” indicating an organic compound in which the organic colouring unit is not chemically bonded to a polymer chain.

Preferably, the cross-linkable system of this primary coating is a system cross-linkable by radiation, in particular UV, and comprises at least one oligomer, at least one diluting monomer and at least one photoinitiator. According to a preferred embodiment this oligomer and this monomer contain acrylic and methacrylic functions able to cross-link in the presence of the appropriate photoinitiator when subjected to UV radiation.

According to another aspect, the invention relates to a photo cross-linkable system of acrylic type for the coating of optical fibres comprising at least one acrylate-terminal oligomer, at least one acrylate-terminal monomer and at least one dye, characterised in that said dye is an organic dye soluble in said cross-linkable system and substantially insoluble in water.

Preferably, said organic dye has a solubility in ethyl alcohol of greater than or equal to 5 g/l. The solubility of this dye in water is preferably less than or equal to 0.5 g/l.

The invention will be more apparent with reference to the accompanying figures, of which:

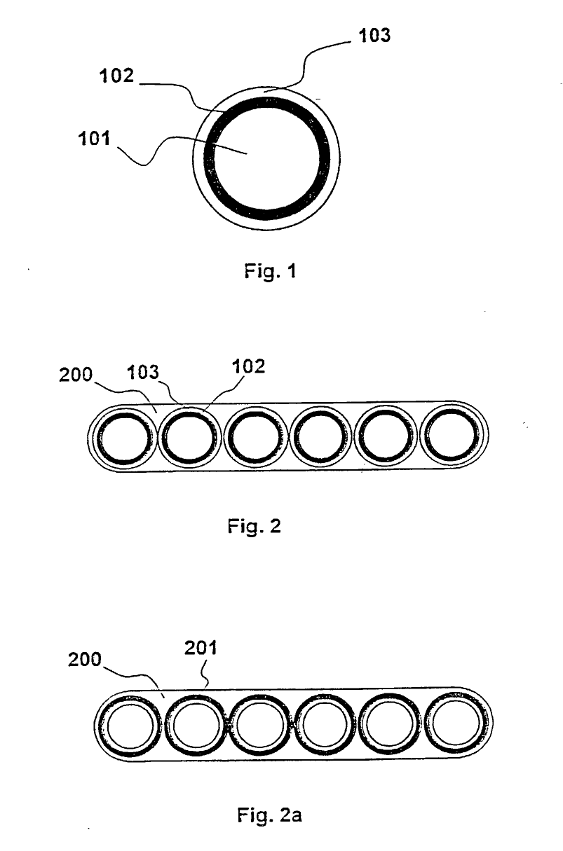

FIG. 1 is a section through an optical fibre of the invention;

FIG. 2 is a section through a fibre optic ribbon comprising a fibre of the invention;

FIG. 2a is a section through a second fibre optic ribbon comprising a fibre of the invention;

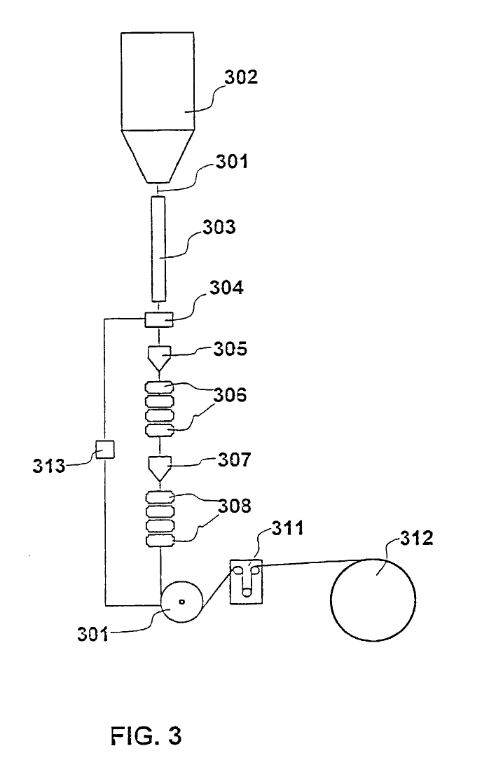

FIG. 3 shows the general scheme of a system (spinning tower) for producing an optical fibre of the invention.

FIG. 1 shows an optical fibre in accordance with this invention, comprising a glass part (101) covered by a coloured primary coating (102), which is itself covered by a secondary coating (103).

A primary coating (102) of the invention comprises typically a cross-linkable system and an organic dye soluble in said cross-linkable system and substantially insoluble in water.

The base cross-linkable system which forms the coating comprises generally at least one oligomer and at least one reactive diluent monomer and is chosen, for example, from systems of silicone, epoxy or acrylic type. Preferably, the base cross-linkable system forms an acrylic resin.

Typically, this base acrylic cross-linkable system comprises at least one oligomer with terminal acrylate or methacrylate groups, at least one diluent monomer of acrylic type and at least one photoinitiator.

The polymerization process which results in the cross-linking of the coating on the optical fibre can be of radical or cationic type or include both. The radical process is generally preferred.

The oligomer represents 40-80% of the formulation by weight. The oligomer is commonly prepared by reaction between a polyol structure, a polyisocyanate and a monomer carrying the function concerned in the cross-linking process. Preferably, this function is a (meth)acrylic group, this definition comprising both the acrylic function and the methacrylic function.

The molecular weight of the polyol structure indicatively lies between 500 and 6000 dalton; it can be entirely of hydrocarbon, polyether, polyester, polysiloxane or fluorinated type, or be a combination thereof. The hydrocarbon and polyether structure are preferred. A structure representative of a polyether polyol comprises polytetramethylene oxide, polymethyltetramethylene oxide, polymethylene oxide polypropylene oxide, polybutylene oxide, their isomers and their mixtures. Structures representative of a hydrocarbon polyol are polybutadiene or polyisobutylene, completely or partly hydrogenated and functionalized with hydroxyl groups.

The polyisocyanate can be of aromatic or aliphatic type. The aliphatic structure is preferred. Examples of aliphatic polyisocyanates are: isophorone diisocyanate, 1,6-hexamethylene-diisocyanate, 2,2,4-trimethyl-1,5-penta-methylene-diisocyanate, 3,3′-diphenylmethane diisocyanate, 4,4′-diphenylmethane diisocyanate.

The monomer carrying the (meth)acrylic function comprises groups able to react with the isocyanic group; examples suitable for the purpose are the hydroxyalkyl(meth)acrylates such as hydroxyethyl(meth)-acrylate and hydroxypropyl(meth)-acrylate.

The diluent monomer represents 20-50% of the formulation by weight, its main purpose being to cause the formulation to attain a viscosity of about 5 Pas at the primary coating application temperature. The diluent monomer carries a reactive function of (meth)acrylic, epoxy or allyl type, depending on the polymerization process chosen, and a structure compatible with that of the oligomer. The acrylic function is preferred.

The diluent monomer can contain an alkyl structure; examples are isobornylacrylate, octylacrylate, decylacrylate and their isomers; or can contain an aromatic group, examples being nonylphenyletheracrylate and polyethyleneglycol-phenyletheracrylate.

The photoinitiator is necessary when cross-linking by irradiation with UV rays. If the polymerization is of radical type, the photoinitiator usually pertains to the class comprising alpha-hydroxy ketones, alpha-amino ketones, benzodimethyl ketals, acylphosphine oxides and their mixtures.

The photoinitiator quantity corresponds to 1-5% of the formulation by weight.

Conventional additives can be added to improve the basic characteristics of the formulation. For example promoters for promoting adhesion to the glass from which the optical fibre is formed, inhibitors inhibiting polymerization by the effect of temperature and light stabilizers can be used. Commonly used glass adhesion promotors are organosilanes, such as triethoxy-trimethylmercapto-silane in a quantity of 0.2-2.0%.

A typical formulation of a primary coating for optical fibres comprises about 45-65% of polyurethaneacrylate, about 30-50% of diluent monomer, about 0.5-2% of photoinitiator and about 0.5-5% of additives.

As stated heretofore, the Applicant has achieved coloration of the coating, in particular the primary coating, using dyes of high compatibility with the constituents of the base cross-linkable system, ie able to dissolve completely in this system. In particular, these dyes are particularly compatible with oligomers or monomers of acrylic type and their mixtures. In this respect, microscopic examination has shown that proper solutions of these dyes form, both in the base cross-linkable system and in the individual oligomer or monomer components of these mixtures, without the undesirable formation of particle aggregates which are observed when using insoluble pigments.

The Applicant has observed that the dye solubility must be such as to enable an adequate concentration of the dye in the base cross-linkable system to be obtained, sufficient to give the final resin the desired colour intensity. The Applicant has observed that a quantity of about 0.1-0.5% by weight of dye in the final resin already gives a more than acceptable coloration, hence the dye solubility in the base cross-linkable system is preferably at least 5 g/l or greater. To enable the desired concentration to be easily attained in the cross-linkable system, this dye preferably has a solubility in said cross-linkable system equal to or greater than 20 g/l, a solubility equal to or greater than 100 g/l being particularly preferred.

However, as information concerning the solubility of said dyes in the commonly used cross-linkable systems or in their individual components (oligomers and/or monomers) is not always readily available or evaluatable, the Applicant has observed that sufficiently reliable information concerning the solubility of such dyes in the base cross-linkable system can be obtained from the solubility values of these dyes in ethyl alcohol. As observed by the Applicant, dyes particularly suitable for the purposes of this invention are those organic dyes having a solubility in ethyl alcohol of at least 5 g/l. This solubility is preferably at least 20 g/l, and more preferably at least 100 g/l. From the ensuing description relative to methods for preparing base polymer mixtures comprising an organic dye according to the invention, it will be appreciated that a very high solubility of the organic dye in ethyl alcohol is particularly advantageous for preparing very concentrated solutions (up to about 500 g/l) of this dye in a base monomer of the mixture or in a suitable solvent, which is then added to the cross-linkable composition.

A high dye solubility means that the final primary coating composition can comprise 10% or more of the dye by weight on the total weight of the composition. However the colouring power of the organic dyes of the invention is such that a quantity of less than 2% and in particular between 0.1% and 1% by weight is sufficient to give the optical fibre an adequate colour intensity. The colour intensity can be evaluated, for examnple, by using a colorimeter (for example the Minolta Chromameter CR-300) or corresponding colorimetric tables. The evaluation can be done using ASTM D1535-80.

A further characteristic of the organic dyes of this invention is their substantial insolubility in water. In particular, organic dyes which have proved suitable for the purposes of this invention are those having a solubility in water of less than at least about 0.5 g/l. Preferably, the solubility of these dyes in water is less than 0.1 g/l, and more preferably less than 0.05 g/l.

As stated heretofore, this characteristic of substantial dye insolubility in water is essential to prevent it being able to diffuse to the outside of the coating layers when the optical fibre remains within a high humidity environment for a prolonged time. In this respect, as observed experimentally by the Applicant, even if the primary coating on the optical fibre is itself surrounded by the secondary coating, when the optical fibre is in contact with water for a prolonged time and the organic dye solubility exceeds 0.5 g/l, dye migration is observed firstly into the secondary coating and then to the outside of this coating. If an operator has subsequently to work on the optical fibre, its recognition becomes extremely difficult because of its loss of coloration.

Examples of organic dyes suitable for implementing the invention are azocomplexes, phthalocyanine or metal complexes such as those described in EP-A-0655645, U.S. Pat. No. 5,851,621 and U.S. Pat. No. 4,784,905, incorporated herein for reference.

Examples of suitable commercially available dyes are NEOZAPON^{R} and NEOPEN^{R} manufactured by BASF or ORASOL^{R} manufactured by CIBA. In particular the dyes Neopen Yellow 075, Orasol Yellow 3R. Orasol Yellow 2RLN, Neopen Blue 807, Orasol Blue BL, Orasol Blue GN, Orasol Blue GL, Neopen Red 365, Neozapon Red 335, Neozapon Red 395, Orasol Red 2B and Orasol Red BL are preferred.

As molecule portions free from chromophore groups (such as the macromolecular portions of the polymer dyes described in the said EP-A-0432931) are substantially absent in the molecules of the aforestated organic dyes, the dye quantity to be used to obtain an adequate coloration of the optical fibre coating is relatively small. In this respect, the Applicant has observed that a concentration of about 0.5% by weight of the said commercial organic dyes on the total weight of the polymer primary coating composition is sufficient to give the optical fibre adequate coloration, even if this primary coating is subsequently covered with a secondary coating.

The primary coating can be coloured either by directly adding a suitable quantity of organic dye to the base cross-linkable system of the primary coating or, preferably, by adding a concentrated solution of this dye to the base cross-linkable system. In particular, this concentrated solution (also known as the “mother solution”) can be obtained by separately preparing a concentrated solution:

of the dye in the base formulation of the primary coating; or

of the dye in a diluent reactive monomer; or

of the dye in a non-reactive organic solvent;

and adding a suitable quantity of this concentrated die solution to the base formulation of the primary coating.

Adding the dye in the form of a concentrated solution, in particular a diluent monomer solution or a non-reactive solvent solution, is generally preferred to adding the dye as such directly into the base cross-linkable system of the primary coating, as it enables the dye to dissolve better and more rapidly in the base cross-linkable system.

According to a first embodiment of this invention, the dye is hence dissolved in a diluent reactive monomer in which said dye manifests a sufficiently high solubility. This reactive monomer is preferably a monomer which itself forms part of the base cross-linkable system. Alternatively, it can be a reactive monomer different from those which form the base cross-linkable system, but compatible with the other components of the base cross-linkable system.

Reactive diluent monomers usable for dissolving the dye additive are for example those stated heretofore in relation to the composition of the primary coating base cross-linkable system of the invention.

The dye concentration in the diluent monomer solution is preferably the highest possible, to reduce to a minimum the quantity of solution to be added to the base polymer formulation to obtain the desired dye concentration in the formulation, so making the influence of the solvent on the formulation properties negligible, in particular if the monomer does not form part of the base polymer formulation.

The solution obtained in this manner is then added to the primary coating cross-linkable system, to give it the desired coloration.

The additive is dissolved in said solvent preferably under hot conditions, preferably at a temperature of between 40° C. and 80° C.

According to a further embodiment, the dye can be dissolved in a “non-reactive” organic solvent, ie a solvent which does not participate in the cross-linking reaction with the components of the base formulation. This solvent can be chosen, for example, from the most volatile such as acetone, ethyl acetate, ethyl alcohol and methylethylketone.

According to said embodiment, this dissolving takes place at a temperature preferably of between 20° C. and 60° C., the solution obtained then being added to the primary coating composition from which the solvent used for dissolving the additive dye is removed by heating. Again in this case the dye concentration in the non-reactive solvent solution is preferably the highest possible, to reduce to a minimum the solution quantity to be added to the base polymer formulation to obtain the desired dye concentration in the formulation, and limiting to a minimum the operations involved in removing this solvent.

According to an alternative embodiment of the invention, a concentrated dye solution can be prepared in the primary coating base formulation itself. In this embodiment, the dye is added to the primary coating composition preferably at a temperature of between 40° C. and 80° C. Where possible, it is preferable for the dye to be dissolved in the absence of the photoinitiator, to prevent its premature activation during dye dissolution in the case of excessive heating of the mixture However, the Applicant has observed that operating under normal dissolution conditions, the presence of the photoinitiator does not cause any particular problem. The dye concentration is preferably the highest possible, comparable with the dye solubility, to reduce the volume of “mother” dye mixture to be used.

This concentrated dye mixture is then added to the primary coating base polymer mixture in such a quantity as to obtain the desired dye concentration in the final composition to be cross-linked.

In an alternative embodiment of the invention, the dye can be dissolved directly in the primary coating composition.

In this embodiment, the dye is added to the primary coating composition preferably at a temperature of between 40° C. and 80° C.

As stated heretofore, although it is preferable to dissolve the dye in the absence of the photoinitiator, it has been observed that operating under normal dissolution conditions, the presence of the photoinitiator does not cause any particular problem.

The primary coating base polymer composition can be formulated with the aforedescribed components, in accordance with the known art. Advantageously, commercially available formulations can be used, such as Desolite^{R} 3471-1-129 of DSM (Holland).

The aforedescribed primary coating is then covered with a secondary coating, of a type known in the art, compatible with the primary coating formulation. For example, if the primary coating has an acrylic base, the secondary coating will also preferably have an acrylic base.

Typically, an acrylic based secondary coating comprises at least one oligomer with acrylate or methacrylate terminal groups, at least one acrylic diluent monomer and at least one photoinitiator.

The oligomer represents generally 40-80% of the formulation by weight. The oligomer commonly consists of a polyurethaneacrylate.

The polyurethaneacrylate is prepared by reaction between a polyol structure, a polyisocyanate and a monomer carrying the acrylic function.

The molecular weight of the polyol structure is indicatively between 500 and 6000 u.a.; it can be entirely of hydrocarbon, polyether, polyester, polysiloxane or fluorinated type, or be a combination thereof. The hydrocarbon and polyether structure and their combinations are preferred. A structure representative of a polyether polyol can be, for example, polytetramethylene oxide, polymethyltetramethylene oxide, polymethylene oxide, polypropylene oxide, polybutylene oxide, their isomers and their mixtures. Structures representative of a hydrocarbon polyol are polybutadiene or polyisobutylene, completely or partly hydrogenated and functionalized with hydroxyl groups.

The polyisocyanate can be of aromatic or aliphatic type. Examples of aliphatic polyisocyanates are: isophorone diisocyanate, 1,6-hexamethylene- diisocyanate, 2,2,4-trimethyl-1,5-pentamethylene diisocyanate, 3,3′-diphenylmethane diisocyanate, 4,4′-diphenyl-methane diisocyanate.

The monomer carrying the acrylic function comprises groups able to react with the isocyanic group; examples suitable for the purpose are the hydroxyalkyl(meth)acrylates such as hydroxyethyl-(meth)acrylate and hydroxypropyl(meth)-acrylate.

The epoxy acrylate is prepared by reacting the acrylic acid with a glycidylether of an alcohol, typically bisphenol A or bisphenol F.

The diluent monomer represents 20-50% of the formulation by weight, its main purpose being to cause the formulation to attain a viscosity of about 5 Pas at the secondary coating application temperature. The diluent monomer, carrying the reactive function, preferably of acrylic type, has a structure compatible with that of the oligomer. The acrylic function is preferred. The diluent monomer can contain an alkyl structure, such as isobornylacrylate, hexanediacrylate, dicyclopentadiene-acrylate, trimethylolpropane-triacrylate, or aromatic such as nonylphenyletheracrylate, polyethyleneglycol-phenyletheracry-late and acrylic derivatives of bisphenol A.

The photoinitiator is necessary when cross-linking by irradiation with UV rays. If the polymerization is of radical type, the photoinitiator usually pertains to the class comprising alpha-hydroxy ketones, alpha-amino ketones, benzodimethyl ketals, acylphosphine oxides and their mixtures. The photoinitiator quantity corresponds to 1-5% of the formulation by weight.

Further additives can be added to improve the basic characteristics of the formulation. For example, inhibitors inhibiting polymerization by the effect of temperature, light stabilizers, levelling agents and detachment promotors for subsequent coatings can be used.

A typical formulation of a cross-linkable system for secondary coatings comprises about 40-70% of polyurethaneacrylate, epoxyacrylate or their mixtures, about 30-50% of diluent monomer, about 1-5% of photoinitiator and about 0.5-5% of other additives.

An example of a formulation usable as the secondary coating of the invention is that marketed under the name of Desolite^{R} 3471-2-136 (DSM). The fibres obtained thereby can be used either as such within optical cables, or can be combined, for example in ribbon form as indicated in FIG. 2, by incorporation into a common polymer covering (200), of a type known in the art (such as Cablelite^{R} 3287-9-53, DSM), to be then used to form an optical cable.

An optical fibre according to this invention can be produced by normal spinning methods, using for example a system such as that shown schematically in FIG. 3.

This system, commonly known as a “drawing tower”, comprises typically a furnace (302) containing an optical glass preform to be drawn. The lower part of this preform is heated to its softening temperature and drawn into an optical fibre (301). The fibre is then cooled, preferably within a suitable cooling tube (303), and passed through a diameter measurement device (304). This device is connected via a microprocessor (313) to a pulley (310) which regulates the drawing speed; if the fibre diameter varies, the microprocessor (313) acts to adjust the rotational speed of the pulley (310), to maintain the diameter of the optical fibre constant. The fibre then passes through a primary coating applicator (305) containing the coating resin in the liquid state, to be covered with the resin to a thickness of about 25-35 μm. The coated fibre is then passed through an UV oven (or a series of ovens) (306) where the primary coating is cross-linked. The fibre covered with the cross-linked primary coating is then passed through a second applicator (307) where it is covered with the secondary coating, and is then cross-linked in the relative UV oven (or ovens) (308). Alternatively, the secondary coating can be applied directly onto the primary coating before this is cross-linked, by using the wet-on-wet method. In this case a single applicator is used, enabling the two coating layers to be applied sequentially, for example of the type described in U.S. Pat. No. 4,474,830. The fibre coated in this manner is then cross-linked using one or more UV ovens similar to those used for cross-linking the individual coatings.

After these coatings have been applied and cross-linked, the fibre can be optionally passed through a device for giving the fibre a predetermined twist, for example of the type described in WO9967180, in order to reduce the PMD (polarization mode dispersion) of this fibre. The pulley (310) positioned downstream of the aforedescribed devices controls the fibre drawing speed.

After leaving this draw pulley the fibre passes through a device (311) for controlling the fibre tension, and is finally collected on a spool (312).

An optical fibre produced in this manner can be used for producing optical cables. The fibre can be used either as such or in the form of ribbons comprising several fibres bound together by a common covering.

The Applicant has verified that an optical fibre of this invention, in particular with its coloured primary coating in direct contact with the glass part of the optical fibre, does not undergo substantial attenuation of the signal transmitted within the fibre, precisely because of the complete dissolution of the dye within the coating.

Although the invention has been described with particular reference to a coloured primary coating covered with a secondary coating, it is apparent from said description that under suitable conditions the coloured coating could instead be the secondary coating of the fibre.

In particular, the Applicant has observed that it is generally preferable to avoid direct contact between a coloured coating of the invention and the waterblocking fillers commonly used in optical cables to prevent or limit water entry into the cable structure. In this respect these waterblocking substances are generally oils or greases comprising typically silicone, mineral (for example naphthenic or paraffinic) or synthetic (for example polyolefinic) base oils. Because of the relatively high solubility of the aforedescribed dyes in organic substances, the Applicant has observed that when the coloured coating is in direct contact with such a waterblocking filler, the dye contained in it can undergo migration towards the filler mass, with consequent fibre decoloration. None of this happens if the coloured coating is itself covered with a second polymer covering which prevents direct contact between the filler and the coloured coating. Because of this, the coloured coating of the invention can be used as the secondary coating in those cases in which the fibre is used in the absence of a waterblocking filler or if direct contact with this filler is prevented. For example, as shown in FIG. 2a, such a coloured secondary coating (201) can be used if this fibre is itself surrounded by a common covering (200), to form a fibre optic ribbon, so as to separate this secondary coating from the external environment and hence from the waterblocking filler.

The following examples illustrate the invention in greater detail, but Without limiting it.

### EXAMPLE 1

Characterisation of the dyes used in the examples. The dye solubility in ethyl alcohol was determined in accordance with ISO 7579. The dye solubility in water was determined by measuring the maximum quantity of dye which dissolves in water at 85° C. within two hours. For this purpose, 100 ml of demineralized water are poured into a conical flask, about 0.5 g of dye are added, the flask is closed with a glass stopper, agitated and placed in an oven at 85° C. The thermal treatment extends for two hours with frequent intermittent agitation. The mixture is allowed to cool to ambient temperature, then filtered under slight vacuum using a Millipore^{R} membrane with 0.45 μm pores.

The liquid is collected in a previously calibrated capsule, evaporated and dried completely in an oven at 105° C. After cooling in a dryer, the residue remaining in the capsule is weighed with an analytical balance. The result is expressed in mg/100 ml. In parallel, a blank test is carried out using only demineralized water. The solubility in ethyl alcohol and water of the dyes used in the subsequent preparations are given in Table 1 below.

TABLE 1
Dye solubility in ethyl alcohol and water

| | Dye | Manufacturer | S1 | S2 |
|---|---|---|---|---|
| 1 | Neopen yellow 075 | BASF | 10 | 0.097 |
| 2 | Orasol yellow 4GN | CIBA | 800 | 3.000 |
| 3 | Orasol yellow 2GLN | CIBA | 300 | 0.560 |
| 4 | Orasol yellow 3R | CIBA | 150 | 0.386 |
| 5 | Orasol yellow 2RLN | CIBA | 700 | 0.046 |
| 6 | Neopen blue 807 | BASF | 120 | 0.029 |
| 7 | Orasol blue BL | CIBA | 700 | 0.158 |
| 8 | Orasol blue GN | CIBA | 250 | 0.015 |
| 9 | Orasol blue GL | CIBA | 25 | 0.038 |
| 10 | Neopen red 365 | BASF | 500 | 0.066 |
| 11 | Neozapon red 335 | BASF | >500 | 0.033 |
| 12 | Neozapon red 395 | BASF | 100 | 0.401 |
| 13 | Orasol red 3GL | CIBA | 350 | ins. |
| 14 | Orasol red 2B | CIBA | 350 | 0.034 |
| 15 | Torasol red BL | CIBA | 150 | 0.032 |
| A | Matrolex yellow 3G | BAYER | 1 | 0.386 |
| B | Special red 3R | BAYER | 4 | 0.010 |

S1 = Solubility in 99.5% C₂H₅OH (g/l);
S2 = Solubility in water (g/l);
ins. = it was not possible to determine the solubility because of the impossibility of dissolving even a minimum quantity of dye.

As can be seen from Table 1. dyes 2 and 3 have a solubility in water which exceeds the maximum of 0.5 g/l so that, as shown in the subsequent examples, these dyes are not sufficiently stable when the coating comes into contact with water. In contrast, dyes A and B shown insufficient solubility in ethyl alcohol, so that it is difficult to prepare sufficiently concentrated solutions of these dyes in suitable organic solvents or in the base mixtures of the primary coating.

In the same manner, the solubilities in water and ethyl alcohol of the pigments given in Table 1a were measured.

TABLE 1a
Solubility of pigments in ethyl alcohol and water.

| Pigment | Manufacturer | S1 | S2 |
|---|---|---|---|
| Yellow Irgalite LIBW | CIBA-GEIGY | 0.38 | 0.008 |
| Violet Carbazole 246-1670 | SUN CHEMICAL | 0.019 | 0.004 |
| Cyanine Lutetia Y500 | FRANCOLOR | 0.007 | 0.001 |

S1 = Solubility in 99.5% C₂H₅OH (g/l);
S2 = Solubility in water (g/l).

Because of the extremely low solubility in ethyl alcohol of the pigments given in Table 1a, it is not possible to obtain a sufficiently concentrated solution of these pigments in the primary coating base mixture to give adequate coloration to the optical fibre. These pigments have therefore to be dispersed in the form of particles in the base mixture, with consequent possible phase separation and formation of particle aggregates, which can cause microbending.

### EXAMPLE 2

Preparation of the coloured primary coating by directly dissolving the dye in the primary acrylate.

99.5 g of Desolite^{R} 3471-1-129 primary coating formulation (DSM, Holland) are weighed into a 250 ml beaker and 0.5 g of dye are added (see Table 2 for the dyes used). The mixture is then put under mild agitation until the dye has completely dissolved (4-8 hours), with moderate heating to a temperature of about 50° C. and applying agitation. Dissolution was verified by examining the product for undissolved crystals under a microscope.

### EXAMPLE 3

Preparation of the coloured primary coating by adding to the primary coating base mixture a concentrated solution of the dye in this mixture.

A coloured “mother” solution of the primary acrylate is prepared in the following manner:

30 g of Desolite^{R} 3471-1-129 formulation (DSM, Holland) are weighed into a 100 ml beaker and put under agitation then, while mildly agitating, successive 0.2 g portions of dye are added until the concentration indicated in Table 2 is achieved. Adequate dissolution, which can be facilitated by operating at moderate temperature (not exceeding 50° C.), is checked by examining a portion of the material under a microscope.

The exact concentration of the “mother” solution is calculated from the dye quantity added, and hence the amount of this solution to be added to the Desolite^{R} 3471-1-129 formulation. The “mother” solution is finally mixed homogeneously into the Desolite^{R} 471-1-129 formulation at ambient temperature, in a quantity such as to obtain a final concentration of about 0.5% by weight of the dye in the primary coating base mixture.

### EXAMPLE 4

Preparation of the coloured primary coating by adding to the primary coating base material a “mother” solution of the dye in reactive acrylic monomer.

A concentrated solution of dye is prepared in an acrylic monomer which, by participating in the subsequent cross-linkage, is to form an integral part of the system. The acrylic monomer used is 2(N-butylcarbamate) ethylacrylate. 30 g of 2(N-butylcarbamate) ethylacrylate are weighed into a 100 ml beaker and put under agitation then, while mildly agitating, successive 0.2 g portions of dye are added to a final concentration of 50-200 g/l depending on its solubility limit (see Table 2 for the particular dye used for this preparation and its concentration in the mixture). The dissolution, which can be facilitated by operating at moderate temperature (not exceeding 80° C.), is verified by examining a portion of the material under a microscope.

The exact concentration of the “mother” solution is calculated from the dye quantity added, and hence the amount of this solution to be added to the Desolite^{R} 3471-1-129 formulation. The “mother” solution is finally mixed homogeneously into the Desolite^{R} 3471-1-129 formulation at ambient temperature, in a quantity such as to obtain a final concentration of about 0.5% by weight of the dye in the primary coating base mixture.

### EXAMPLE 5

Preparation of the coloured primary coating by adding to the primary coating-base material a “mother” solution of the dye in non-reactive organic solvent.

40 ml of 95% ethyl alcohol are fed into a 100 ml beaker then, agitating mildly, successive 1 g portions of dye are added to a final concentration of 100-150 g/l depending on its solubility limit (see Table 2 for the particular dye used for this preparation and its concentration in the mixture). Adequate dissolution, which can be facilitated by operating at moderate temperature (not exceeding 50° C.), is verified by examining a portion of the material under a microscope.

The exact concentration of the “mother” solution is calculated from the dye quantity added, and hence the amount of this solution to be added to the Desolite^{R} 3471-1-129 formulation. The “mother” solution is finally mixed homogeneously into the Desolite^{R} 3471-1-129 formulation at ambient temperature, in a quantity such as to obtain a final concentration of about 0.5% by weight of the dye in the primary coating base mixture.

The excess solvent is eliminated in a rotary evaporator by heating to a temperature of about 50° C. and flushing with a light current of dry air.

TABLE 2
Dye concentration (g/l) in the “mother” solutions prepared in Examples
3-5.

| | Dye | Ex. 3 | Ex. 4 | Ex. 5 |
|---|---|---|---|---|
| 1 | Neopen yellow 075 | — | 5 | — |
| 2 | Orasol yellow 4GN | — | 90 | 80 |
| 3 | Orasol yellow 2GLN | 50 | 85 | — |
| 4 | Orasol yellow 3R | — | 69 | — |
| 5 | Orasol yellow 2RLN | — | — | 70 |
| 6 | Neopen blue 807 | 50 | — | 50 |
| 7 | Orasol blue BL | — | 78 | — |
| 8 | Orasol blue GN | — | — | 80 |
| 9 | Orasol blue GL | 50 | — | — |
| 10 | Neopen red 365 | — | 36 | — |
| 11 | Neozapon red 335 | 50 | — | — |
| 12 | Neozapon red 395 | — | 110 | 50 |
| 13 | Orasol red 3GL | 50 | 50 | 80 |
| 14 | Orasol red 2B | — | 140 | — |
| 15 | Orasol red BL | 50 | 36 | — |

From the aforedescribed examples and the data given in Table 2, it can be seen that all the organic dyes used enable very concentrated solutions of these dyes to be prepared, both in organic solvents and in the primary coating base material.

### EXAMPLE 6

Evaluation of the dye stability.

The stability of the dye towards water and towards optical cable filler materials with which optical fibres are usually in contact was evaluated.

Two sets of cross-linked test pieces were prepared, to evaluate the stability of the dye:

when dissolved in a primary coating positioned in direct contact with water or with the filler material; or

when dissolved in a primary coating itself covered with a secondary coating in contact with water or with the filler material.

The coloured primary coating from which all the test pieces were made was prepared by the method described in Example 4.

A. Preparation of the Coloured Primary Coating Test Piece.

For the test involving direct exposure of the primary coating to water and to the filler, the film must be supported on one side by a secondary film to prevent the primary film, which is soft and sticky, from curling and folding back on itself.

A film of secondary coating (Desolite^{R} 3471-2-136, DSM) of 70 μm thickness and 100 mm width is spread onto a glass plate using a “Bird” filmograph at a speed of 2 cm per minute; the film is cross-linked using the Fusion UV Curing System Model F600 and a D spectrum lamp (applying a UV dose of 1.25 J/cm²). The coloured primary coating film (prepared as in Example 4) is spread onto the already prepared film to a thickness of 40 μm and width of 50 mm using the filmograph. It is completely cross-linked by applying a UV dose of 5 J/cm².

B. Preparation of the Test Piece Comprising Coloured Primary Coating Covered with a Secondary Coating.

A film of secondary coating (Desolite^{R} 3471-2-136, DSM) of 70 μm thickness and 75 mm width is spread onto a glass plate using the “Bird” filmograph at a speed of 2 cm per minute; the film is cross-linked with a UV dose of 1.25 J/cm² using the Fusion system.

A coloured primary coating film (prepared as in Example 4) is spread onto the already prepared film to a thickness of 40 μm and width of 50 mm using the filmograph, being careful to cover only the central surface of the underlying secondary film. It is cross-linked with a UV dose of 5 J/cm². Finally, another layer of secondary coating is spread to a thickness 70 μm and width of 100 mm using the filmograph and is cross-linked with a UV dose of 5 J/cm².

6.1 Evaluation of Solubility in Water.

The two sets of test pieces, prepared as heretofore described, are removed from the glass plate and immersed in distilled water contained in two 250 ml beakers; the beakers are covered to limit water evaporation and are placed in an oven temperature controlled at 85° C. The treatment extends for 15 days, if necessary adding distilled water when the level falls. On termination, any water coloration (in the case of the primary coating alone) or any coloration of the secondary coating and water (in the case of primary coating covered with the secondary coating) is noted to provide a qualitative evaluation of the situation.

6.2 Evaluation of Solubility in Contact with a Waterblocking Filler.

The test pieces prepared as heretofore described are left on the glass support plate: the exposed surface is covered with a layer of about 0.5 mm of polyolefin waterblocking filler (LA444, manufactured by Hüber), after which the test pieces are maintained in an oven temperature controlled at 85° C. for 15 days. On termination of this aging, any coloration of the filler (in the case of primary coating alone) or any coloration of the secondary coating and filler (in the case of primary coating covered with the secondary coating) is noted, to provide a qualitative evaluation of the situation.

Table 3 shows the results of the aforedescribed tests.

TABLE 3
Evaluation of dye stability

| | | | | Coloured primary | |
|---|---|---|---|---|---|
| | | Coloured primary | | coating with secondary | |
| | | coating, uncovered | | coating | |
| | Dye | in water | in LA 444 | in water | in LA 444 |
| 1 | Neopen yellow 075 | — | − | + | + |
| 2 | Orasol yellow 4GN | − | − | − | + |
| 3 | Orasol yellow 2GLN | − | − | − | + |
| 4 | Orasol yellow 3R | − | − | + | + |
| 5 | Orasol yellow 2RLN | — | − | + | + |
| 6 | Neopen blue 807 | — | − | + | + |
| 7 | Orasol blue BL | − | — | + | + |
| 8 | Orasol blue GN | + | − | — | + |
| 9 | Orasol blue GL | − | − | + | + |
| 10 | Neopen red 365 | − | − | + | + |
| 11 | Neozapon red 335 | + | − | + | + |
| 12 | Neozapon red 395 | + | − | + | + |
| 13 | Orasol red 3GL | — | − | + | + |
| 14 | Orasol red 2B | + | − | + | + |
| 15 | Orasol red BL | − | − | + | + |

+: water or filler coloration not observed
−: water or filler coloration observed

From the data given in Table 3, it can be seen that the organic dyes of this invention, ie with a solubility in water of less than 0.5 g/l show adequate stability when the coating in which they are dissolved comes into contact with water, in particular if the primary coating is covered with a secondary coating. In some cases (1. 5-6. 8-9. 11-15), even direct contact between the coloured coating and water does not cause the dye to migrate into the water. In contrast, the organic dyes 2 and 3 (with a solubilitymigration even when the primary secondary is covered with a secondary coating.

In the case of contact with a polyolefin waterblocking filler, no dye migration is observed if the primary coating is covered with a secondary coating.

### EXAMPLE 7

Attenuation tests on optical fibre.

An optical fibre was produced in accordance with the known art, comprising a primary coating prepared as in Example 4 (containing 0.5% by weight of the organic dye Orasol yellow 2RLN) and a secondary coating of Desolite^{R} 3471-2-136.

The optical fibre coloration was perfectly visible in the finished fibre.

A coil of 1000 m length of the fibre produced in this manner was subjected to aging in water at a temperature of 60° C. for 120 days. During aging, attenuation measurements were taken at regular intervals by the back-scattering method, using an OTDR (optical time domain reflectometer) type ANRITSU mod. MW 90-60 A. The measurements taken showed no anomalies (attenuation values substantially constant), and no water coloration was observed on termination of the test.

A second coil of 1000 m length was aged at 85° C. under 85% relative humidity for 120 days in hyrocarbon filler LA444 (HUBER). Again in this case the measurements taken showed no anomalies (attenuation values substantially constant), and no filler coloration was observed on termination of the test.

1. An optical fibre comprising a coloured polymer coating formed from a cross-linkable system characterised in that said polymer coating comprises an organic dye soluble in said cross-linkable system and substantially insoluble in water.

2. An optical fibre as claimed in claim 1, characterised in that said coloured polymer coating is a primary coating.

3. An optical fibre as claimed in claim 1, characterised in that the solubility of said dye in the cross-linkable system is greater than or equal to 5 g/l.

4. An optical fibre as claimed in claim 1, characterised in that the solubility of said dye in the cross-linkable system is greater than or equal to 20 g/l.

5. An optical fibre as claimed in claim 1, characterised in that the solubility of said dye in the cross-linkable system is greater than or equal to 100 g/l.

6. An optical fibre as claimed in claim 1, characterised in that the solubility of said organic dye in ethyl alcohol is greater than or equal to 5 g/l.

7. An optical fibre as claimed in claim 1, characterised in that the solubility of said organic dye in ethyl alcohol is greater than or equal to 20 g/l.

8. An optical fibre as claimed in claim 1, characterised in that the solubility of said organic dye in water is less than or equal to 0.5 g/l.

9. An optical fibre as claimed in claim 1, characterised in that the solubility of said organic dye in water is less than or equal to 0.1 g/l.

10. An optical fibre as claimed in claim 1, characterised in that the solubility of said organic dye in water is less than or equal to about 0.05 g/l.
